(19) United States
(12) Patent Application Publication
(10) Pub. No.: US 2021/0274987 A1
(43) Pub. Date: Sep. 9, 2021

(54) SELF-PROPELLED VACUUM CLEANER

(71) Applicant: Panasonic intellectual Property Management Co., Ltd., Osaka (JP)

(72) Inventors: Masahiro KAWAI, Shiga (JP); Yoshifumi KORI, Kyoto (JP)

(21) Appl. No.: 17/259,870

(22) PCT Filed: Jun. 21, 2019
(86) PCT No.: PCT/JP2019/024666

§ 371 Date: Jan. 12, 2021

(30) Foreign Application Priority Data
Jul. 20, 2018 (JP) 2018-137036

(51) Int. Cl. A47L 9/00; A47L 9/28; G05D 1/02; G01S 15/931

(52) U.S. Cl. CPC A47L 9/009; A47L 9/2852; A47L 9/2826; G05D 2201/0215; G01S 15/931; A47L 2201/04; G05D 1/0246

(57) ABSTRACT

Provided is a self-propelled vacuum cleaner including a main body, drive unit that moves and turns the main body, and an obstacle detector (an obstacle sensor, a ranging sensor, a camera) that detects an obstacle around the main body. The self-propelled vacuum cleaner further includes a lifter that lifts the main body from a floor surface, and a controller that controls a drive unit and the lifter based on a detection result of the obstacle detector. The controller controls the drive unit to cause the main body to avoid the obstacle while releasing lifting using the lifter when the obstacle has a depth in a traveling direction of the main body, the depth being smaller than a predetermined value. In contrast, when the depth is equal to or more than the predetermined value, the drive unit is controlled to cause the main body to run on the obstacle while being lifted by the lifter. This increases certainty of cleaning for the obstacle.

### TECHNICAL FIELD

The present invention relates to a self-propelled vacuum cleaner that performs cleaning while running autonomously.

### BACKGROUND ART

There is conventionally known a self-propelled vacuum cleaner including a lifter for lifting its main body from a floor surface to run over an obstacle such as an electric cord (e.g., refer to PTL 1).

Here, when the main body is lifted by the lifter, suction force deteriorates due to a distance from a floor surface to a suction port, the distance increasing to more than that in a normal state. For example, when the obstacle is a rug such as a carpet, the self-propelled vacuum cleaner runs on the rug while having the main body lifted by the lifter. Then, the self-propelled vacuum cleaner exerts normal suction force after the lifted state of the main body is released.

However, when the rug has a narrow depth in a traveling direction of the self-propelled vacuum cleaner, the self-propelled vacuum cleaner will pass through the rug without being released from the lifted state. That is, there is a risk that the self-propelled vacuum cleaner will not clean the rug.

### CITATION LIST

### Patent Literature

### PTL 1: Japanese Patent No. 4277214

### SUMMARY OF THE INVENTION

The present invention provides a self-propelled vacuum cleaner capable of increasing reliability of cleaning on a rug.

The self-propelled vacuum cleaner of the present invention includes a main body that moves on a floor surface to clean the floor surface, a moving unit that is provided on the main body and moves or turns the main body, an obstacle detector provided on the main body and detects an obstacle existing around the main body, a lifter that is provided on the main body and lifts the main body from the floor surface, and a controller that controls the moving unit and the lifter. The controller calculates a depth of the obstacle in a traveling direction of the main body based on a detection result of the obstacle detector. When the depth is smaller than a predetermined value, the controller controls the moving unit to cause the main body to avoid the obstacle while controlling the lifter to release the lifting of the main body.

Implementing a program for causing a computer to execute each process of the self-propelled vacuum cleaner also corresponds to implementation of the present invention. As a matter of course, implementing the program using a recording medium on which the program is recorded also corresponds to the implementation of the present invention.

The present invention enables providing a self-propelled vacuum cleaner capable of increasing reliability of cleaning on a rug.

### BRIEF DESCRIPTION OF DRAWINGS

FIG. 1 is a plan view illustrating an appearance of a self-propelled vacuum cleaner according to an exemplary embodiment from above.

FIG. 2 is a bottom view illustrating the appearance of the self-propelled vacuum cleaner from below.

FIG. 3 is a perspective view illustrating the appearance of the self-propelled vacuum cleaner from diagonally above.

FIG. 4 is a schematic sectional view illustrating a schematic structure of a lifter of the self-propelled vacuum cleaner.

FIG. 5 is a block diagram illustrating a control configuration of the self-propelled vacuum cleaner.

FIG. 6 is a flowchart illustrating an avoidance operation and a running-on operation of the self-propelled vacuum cleaner according to the exemplary embodiment.

FIG. 7 is an explanatory diagram illustrating an operation when the self-propelled vacuum cleaner does not avoid an obstacle.

FIG. 8 is an explanatory diagram illustrating an operation when the self-propelled vacuum cleaner avoids an obstacle.

FIG. 9 is an explanatory diagram illustrating another example of an obstacle of the self-propelled vacuum cleaner.

FIG. 10 is an explanatory diagram illustrating a direction detection operation of the self-propelled vacuum cleaner.

### DESCRIPTION OF EMBODIMENT

Hereinafter, a self-propelled vacuum cleaner according to an exemplary embodiment of the present invention will be described with reference to the drawings. The following exemplary embodiment is merely an example of the self-propelled vacuum cleaner in the present invention. Thus, the present invention is defined by the wording of the scope of claims with reference to the following exemplary embodiment, and is not limited to the following exemplary embodiment. Although components in the following exemplary embodiment includes a component that is not described in the independent claim showing the highest concept of the present invention and that is not necessarily required to achieve an object of the present invention, the component is described to constitute a more preferable form.

The drawings are each a schematic view in which a component is appropriately emphasized, eliminated, and adjusted in ratio to illustrate the present invention, and may be different in shape, positional relationship, and ratio from an actual component.

### Exemplary Embodiment

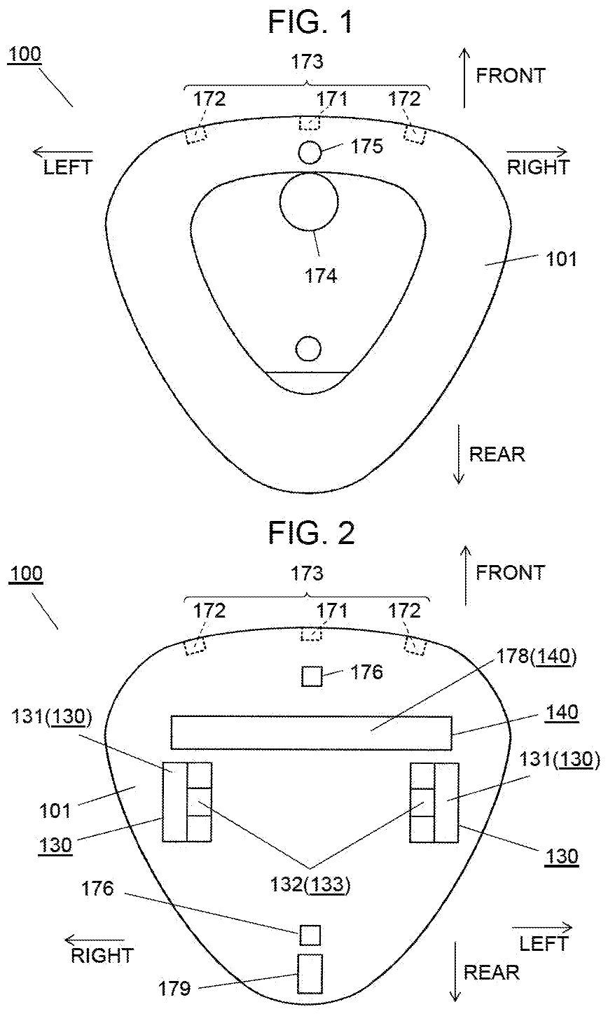

Hereinafter, self-propelled vacuum cleaner 100 according to an exemplary embodiment of the present invention will be described with reference to FIGS. 1 to 3.

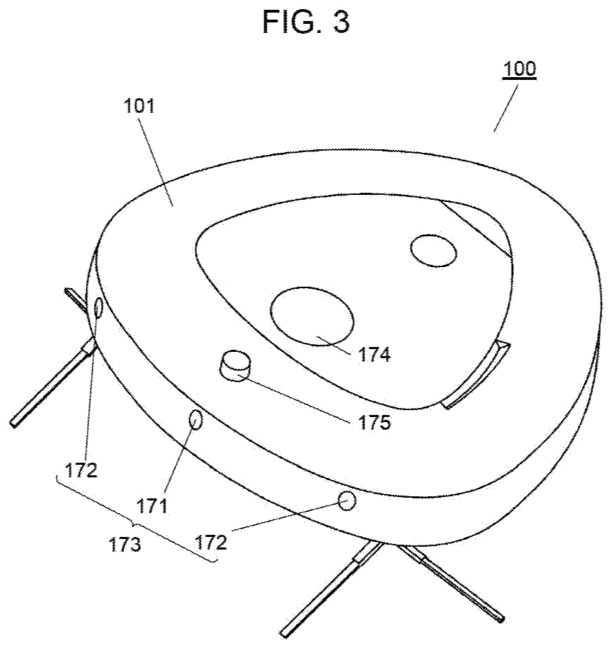

FIG. 1 is a plan view illustrating an appearance of self-propelled vacuum cleaner 100 according to the present exemplary embodiment from above. FIG. 2 is a bottom view illustrating the appearance of self-propelled vacuum cleaner 100 from below. FIG. 3 is a perspective view illustrating the appearance of self-propelled vacuum cleaner 100 from diagonally above.

Self-propelled vacuum cleaner 100 is a cleaning robot that performs cleaning while autonomously moving on a cleaning area such as a floor surface. Specifically, self-propelled vacuum cleaner 100 is a robot vacuum cleaner that autonomously runs in a predetermined cleaning area based on an environmental map described later and sucks dust existing in the cleaning area.

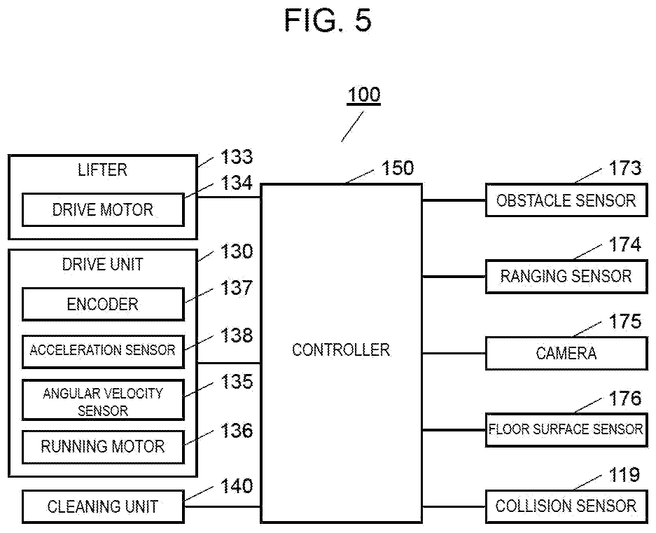

As illustrated in FIGS. 1 to 3, self-propelled vacuum cleaner 100 of the present exemplary embodiment includes main body 101, a pair of drive units 130, cleaning unit 140 having suction port 178, various sensors described later, controller 150 (refer to FIG. 5), lifter 133, and the like. Main body 101 constitutes an outer shell of self-propelled vacuum cleaner 100 that moves on a cleaning area such as a floor surface and cleans the cleaning area. Cleaning unit 140 sucks dust existing in drive unit 130 (refer to FIG. 2) and a cleaning area from suction port 178. A placement relationship is subsequently described, for example, as illustrated in FIG. 1 such that a side on which obstacle sensor 173 described later is disposed is defined as the front, an opposite side is defined as the rear, a right side when facing the front is defined as the right, and a left side when facing the front is defined as the left.

As illustrated in FIG. 2, one drive unit 130 is disposed on each left and right side with respect to the center in a width direction in the left-right direction in plan view of self-propelled vacuum cleaner 100. A number of drive units 130 is not limited to two (pair), and may be one, or three or more.

Each of drive units 130 according to the present exemplary embodiment includes wheel 131 that runs on a floor surface, running motor 136 (refer to FIG. 5) that applies torque to wheel 131, a housing that accommodates running motor 136, and the like. Each of wheels 131 is housed in a recess (not illustrated) formed in a lower surface of main body 101, and is rotatably attached to main body 101.

Self-propelled vacuum cleaner 100 further includes caster 179 as an auxiliary wheel to form an opposed two-wheel type. When rotation of each of wheels 131 of the pair of drive units 130 is independently controlled, self-propelled vacuum cleaner 100 can freely run forward, backward, counterclockwise, clockwise, and the like. Specifically, when each of wheels 131 of the pair of drive units 130 is rotated counterclockwise or clockwise while moving forward and backward, self-propelled vacuum cleaner 100 turns right or left when moving forward or backward. In contrast, when each of wheels 131 of the pair of drive units 130 is rotated counterclockwise or clockwise without moving forward or backward, self-propelled vacuum cleaner 100 turns on the current point. That is, drive unit 130 functions as a moving unit for moving or turning main body 101 of self-propelled vacuum cleaner 100. Then, drive units 130 cause self-propelled vacuum cleaner 100 to run in a cleaning area such as a floor surface based on an instruction from controller 150.

Cleaning unit 140 constitutes a unit that collects dust and sucks the dust from suction port 178. Cleaning unit 140 includes a main brush (not illustrated) disposed in suction port 178, a brush drive motor (not illustrated) for rotating the main brush, and the like. Cleaning unit 140 causes a brush drive motor or the like to operate based on an instruction from controller 150.

A suction device (not illustrated) that sucks dust from suction port 178 is disposed inside main body 101. The suction device includes a fan case and an electric fan disposed inside the fan case (not illustrated). The suction device causes the electric fan or the like to operate based on an instruction from controller 150.

Self-propelled vacuum cleaner 100 further includes various sensors exemplified below, such as obstacle sensor 173, ranging sensor 174, collision sensor 119, camera 175, floor surface sensor 176, acceleration sensor 138, and angular velocity sensor 135.

Obstacle sensor 173 detects an obstacle existing in front of main body 101. The present exemplary embodiment uses an ultrasonic sensor as obstacle sensor 173, for example. Obstacle sensor 173 is composed of, for example, one transmitter 171 and two receivers 172. Transmitter 171 is disposed near the center in front of main body 101 and emits ultrasonic waves toward the front. Receivers 172 are disposed on both sides of transmitter 171 and receive the ultrasonic waves transmitted from transmitter 171. That is, obstacle sensor 173 is configured to allow receiver 172 to receive ultrasonic waves that are transmitted from transmitter 171 and returned by being reflected by an obstacle. This allows obstacle sensor 173 to detect a distance between main body 101 and the obstacle, and a position of the obstacle.

Ranging sensor 174 detects a distance between an object, such as an obstacle or a wall, existing around self-propelled vacuum cleaner 100, and self-propelled vacuum cleaner 100. The present exemplary embodiment includes ranging sensor 174 that is composed of, for example, a so-called laser range scanner that scans with a laser beam and measures a distance based on light reflected from an obstacle. Specifically, ranging sensor 174 is used to create an environmental map described later.

Collision sensor 119 is composed of, for example, a switch contact displacement sensor, and is provided on a bumper or the like disposed around main body 101 of self-propelled vacuum cleaner 100. The switch contact displacement sensor is turned on when an obstacle comes into contact (or collides) with the bumper and the bumper is pushed against self-propelled vacuum cleaner 100. This allows collision sensor 119 to detect contact with an obstacle.

Camera 175 constitutes a device that images a space in front of main body 101. An image captured by camera 175 is subjected to image processing by, for example, controller 150. This processing allows a shape of an obstacle, for example, in a space in front of main body 101 to be recognized from a position of a feature point in the image.

That is, obstacle sensor 173, ranging sensor 174, and camera 175, which are described above, function as an obstacle detector that detects an obstacle existing around main body 101.

As illustrated in FIG. 2, floor surface sensor 176 is disposed at a plurality of locations on a bottom surface of main body 101 of self-propelled vacuum cleaner 100, and detects whether a cleaning area such as a floor surface exists. The present exemplary embodiment includes floor surface sensor 176 that is composed of, for example, an infrared sensor having a light emitter and a light receiver. That is, when light (infrared ray) radiated from the light emitter returns and is received by the light receiver, floor surface sensor 176 determines the state as “with a floor surface”. In contrast, when the light receiver receives only light below a threshold value, floor surface sensor 176 determines the state as “no floor surface”.

Drive units 130 each further include encoder 137, as illustrated in FIG. 5. Encoder 137 detects a rotation angle of each of the pair of wheels 131 rotated by the corresponding one of running motors 136. Based on information from encoder 137, controller 150 calculates, for example, the amount of running, a turning angle, a speed, acceleration, angular velocity, and the like of self-propelled vacuum cleaner 100.

As illustrated in FIG. 5, drive units 130 each further include acceleration sensor 138, angular velocity sensor 135, and the like. Acceleration sensor 138 detects acceleration when self-propelled vacuum cleaner 100 runs. Angular velocity sensor 135 detects angular velocity when self-propelled vacuum cleaner 100 turns. Information detected by acceleration sensor 138 and angular velocity sensor 135 is used for information to correct an error (e.g., deviation between operation instructions such as movement and turning issued by the controller and actual operation results) caused by, for example, racing of wheels 131.

Obstacle sensor 173, ranging sensor 174, collision sensor 119, camera 175, floor surface sensor 176, the encoder, and the like, which are described above, are examples of sensors. Thus, self-propelled vacuum cleaner 100 of the present exemplary embodiment may be further provided with other different types of sensor, such as a dust sensor, a motion sensor, and a charging-stand-position detection sensor, in addition to the above, if necessary.

Self-propelled vacuum cleaner 100 further includes lifter 133. Lifter 133 constitutes a device for lifting at least a part of main body 101.

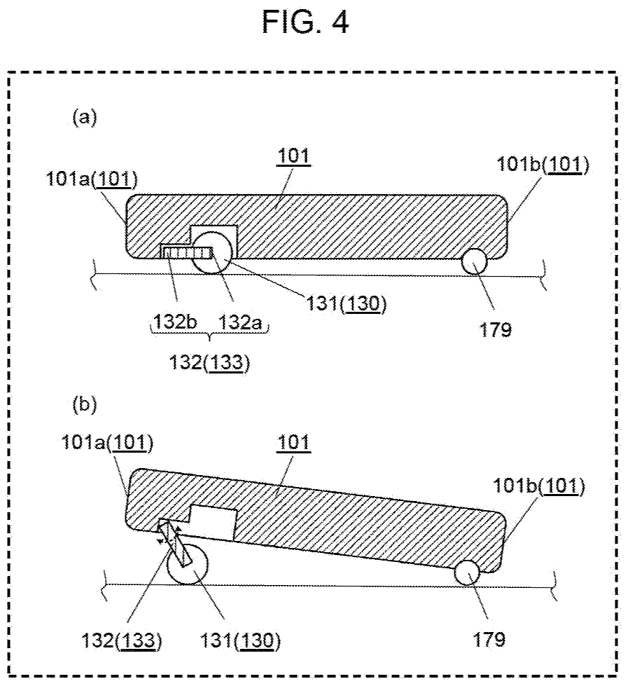

Hereinafter, lifter 133 of self-propelled vacuum cleaner 100 will be described with reference to FIG. 4.

FIG. 4 is a schematic sectional view illustrating a schematic structure of lifter 133 of self-propelled vacuum cleaner 100. Specifically, part (a) of FIG. 4 illustrates a state in which lifting of main body 101 is released by lifter 133 (hereinafter, may be referred to as a “normal state”). Part (b) of FIG. 4 illustrates a state in which main body 101 is lifted by lifter 133 (hereinafter, may be referred to as a “lifted state”).

Lifter 133 is incorporated in drive unit 130 as illustrated in FIGS. 2 and 4. Specifically, lifter 133 includes arm 132, drive motor 134 (refer to FIG. 5), and the like. Arm 132 rotatably holds wheel 131 of drive unit 130 on a side of leading end portion 132a. Drive motor 134 is disposed on a side of base end portion 132b of arm 132, and rotates arm 132 about base end portion 132b. This causes leading end portion 132a of arm 132 to appear and disappear from main body 101.

When leading end portion 132a of arm 132 is housed in main body 101 as illustrated in part (a) of FIG. 4, an installation state of main body 101 is in the normal state. In contrast, when leading end portion 132a of arm 132 projects downward from main body 101 (toward the floor surface) as illustrated in part (b) of FIG. 4, main body 101 is in a lifted state. That is, front portion 101a of main body 101 is lifted above rear portion 101b with respect to the floor surface. This causes main body 101 to be in a tilted state in which front portion 101a is higher than rear portion 101b with respect to the floor surface.

That is, lifter 133 lifts front portion 101a of main body 101 according to a situation of surrounding obstacles. Thus, lifter 133 functions to help main body 101 to run on an obstacle during forward movement without colliding with the obstacle. For example, when the obstacle is a rug such as a carpet, main body 101 being not in the lifted state may come into contact with the rug and roll up the rug. When the rug is rolled up, main body 101 comes into contact with a rolled-up portion and is hindered from running further forward. Specifically, the collision sensor or the like reacts due to the contact to cause main body 101 to perform an avoidance operation, so that main body 101 is hindered from running forward. Further, when main body 101 runs into, or slips into the rolled-up rug, cleaning on the rug cannot be performed. When these conditions occur, cleaning performance of self-propelled vacuum cleaner 100 for the rug is deteriorated.

Thus, self-propelled vacuum cleaner 100 of the present exemplary embodiment is configured such that when the obstacle detector detects a rug such as a carpet, lifter 133 is driven to bring main body 101 into the lifted state. This enables main body 101 to easily run on the rug. Thus, interference between main body 101 and the rug is less likely to occur. As a result, self-propelled vacuum cleaner 100 can achieve stable cleaning performance on the rug.

As described above, self-propelled vacuum cleaner 100 of the present exemplary embodiment is configured and operates.

Hereinafter, a control configuration of self-propelled vacuum cleaner 100 having the above configuration will be described with reference to FIG. 5.

FIG. 5 is a block diagram illustrating a control configuration of self-propelled vacuum cleaner 100.

As illustrated in FIG. 5, controller 150 is electrically connected to drive unit 130, obstacle sensor 173, ranging sensor 174, camera 175, floor surface sensor 176, collision sensor 119, cleaning unit 140, lifter 133, and the like. Although FIG. 5 illustrates only one drive unit 130, drive unit 130 is actually provided corresponding to each of left and right wheels 131. That is, self-propelled vacuum cleaner 100 of the present exemplary embodiment has two drive units 130.

Controller 150 includes, for example, a central processing unit (CPU), a random access memory (RAM), a read only memory (ROM), and the like. Controller 150 controls operation of each of the above-mentioned connected units by allowing the CPU to expand a program stored in the ROM into the RAM and execute the program.

Next, control operation of controller 150 will be described.

Controller 150 accumulates data detected by the various sensors described above. Then, controller 150 integrates the accumulated data to create the environmental map described above. Here, the environmental map is a map of an area where self-propelled vacuum cleaner 100 moves within a predetermined cleaning area and performs cleaning. Although a method for creating the environmental map is not particularly limited, examples thereof include simultaneous localization and mapping (SLAM).

Specifically, controller 150 creates the environmental map by forming information based on a running history of self-propelled vacuum cleaner 100, the information indicating an outer shape of a cleaning area where self-propelled vacuum cleaner 100 has actually run and placement of obstacles that hinders running. The environment map is created as, for example, two-dimensional array data. At this time, controller 150 may process the running history as array data by dividing the running history into quadrangles each having a predetermined size such as 10 cm in length and width, and regarding each of the quadrangles as an element area of an array constituting the environment map. The environmental map may be obtained from a device or the like provided outside self-propelled vacuum cleaner 100.

Controller 150 records a running path during cleaning using each coordinate in the environment map during running of self-propelled vacuum cleaner 100. Specifically, controller 150 detects each coordinate in the environmental map of self-propelled vacuum cleaner 100 based on data detected by the various sensors during cleaning, and records each coordinate as the running path.

Controller 150 further controls cleaning unit 140 and the suction device during cleaning. Specifically, controller 150 controls a brush drive motor of cleaning unit 140 and an electric fan of the suction device so that dust on the floor surface is sucked using suction force generated by the electric fan while a main brush of cleaning unit 140 is rotated.

Controller 150 further controls drive motor 134 of lifter 133 based on a detection result whether an obstacle exists acquired by the obstacle detector, and switches a state of main body 101 between the normal state and the lifted state. Specifically, controller 150 calculates a depth of the obstacle in a traveling direction of main body 101 based on the detection result of the obstacle detector when at least one of obstacle sensor 173, ranging sensor 174, and camera 175, which constitute the obstacle detector, detects the obstacle.

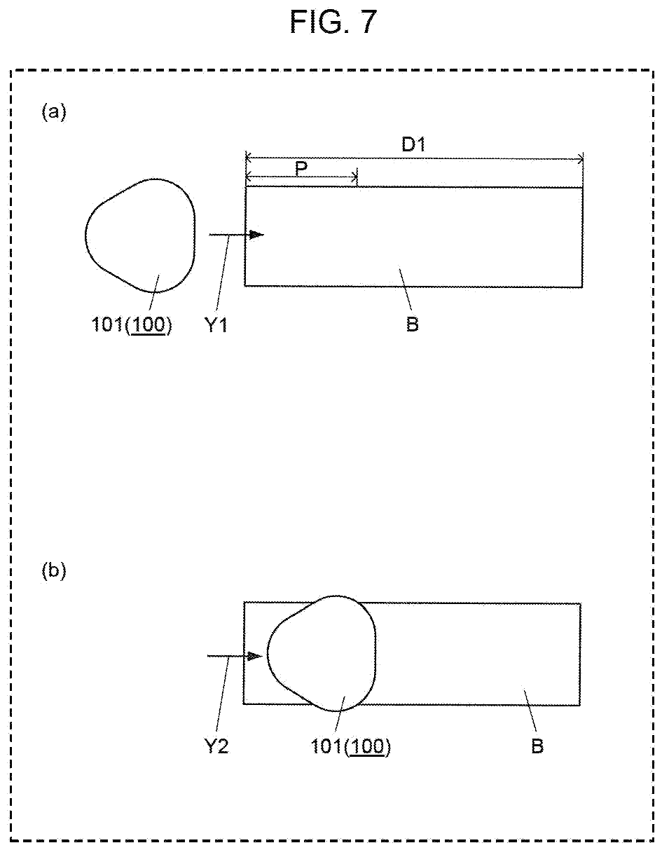

The obstacles described above are classified into an obstacle or obstacle B (refer to FIG. 7 and the like) that self-propelled vacuum cleaner 100 can run over (run on) and an obstacle that self-propelled vacuum cleaner 100 cannot run over. Examples of obstacle B that can be run over include a rug such as a carpet. Examples of the obstacle that cannot be run over include a wall and furniture.

Then, controller 150 determines whether an obstacle is obstacle B that can be run over or the obstacle cannot be run over based on a detection result of collision sensor 119.

Specifically, controller 150 determines that an obstacle cannot be run over when collision sensor 119 indicates a detection result of ON while the obstacle detector detects the obstacle. In contrast, controller 150 determines that an obstacle B can be run over when collision sensor 119 still indicates a detection result of OFF while the obstacle detector detects the obstacle. When a thickness of obstacle B (height from the floor surface) can be detected from an image of the obstacle captured by camera 175, controller 150 may determine whether the obstacle B can be run over or the obstacle that cannot be run over based on the detected thickness.

As described above, controller 150 controls each unit.

Hereinafter, control operation of controller 150 when obstacle B that self-propelled vacuum cleaner 100 can run over is detected, for example, will be described.

First, controller 150 recognizes a shape (particularly, a thickness), a size, a position, etc., of obstacle B, based on an image of obstacle B detected by camera 175.

Next, controller 150 calculates a depth of obstacle B in a traveling direction of self-propelled vacuum cleaner 100 based on the recognized result. When camera 175 does not detect obstacle B, controller 150 may calculates the depth of obstacle B in the traveling direction of self-propelled vacuum cleaner 100 based on a detection result of obstacle sensor 173 or ranging sensor 174.

Subsequently, controller 150 determines whether the depth of obstacle B is smaller than a predetermined value. At this time, when the depth of the obstacle B is equal to or more than the predetermined value, controller 150 first causes main body 101 to run on obstacle B in the lifted state. Then, after main body 101 runs on obstacle B, controller 150 causes main body 101 to clean on obstacle B by switching main body 101 to in the normal state and returning main body 101 to a state in which normal suction force can be exerted. In contrast, when the depth of the obstacle B is smaller than the predetermined value, controller 150 causes main body 101 holding the lifted state to pass over obstacle B after main body 101 runs on obstacle B in the lifted state. This causes main body 101 to pass over obstacle B without cleaning. Thus, controller 150 sets a predetermined value as a threshold value for the depth of obstacle B to prevent main body 101 from simply passing over obstacle B. Specifically, the predetermined value may be longer than a length allowing a state of main body 101 having run on obstacle B to be switched from the lifted state to the normal state on obstacle B. For example, the predetermined value may be larger than a turning diameter of main body 101. That is, when main body 101 can turn on obstacle B, a state of main body 101 can be switched from the lifted state to the normal state on the obstacle B. After that, main body 101 is turned on obstacle B. This enables main body 101 to be changed in direction on obstacle B, and thus enables cleaning on obstacle B.

When the depth of the obstacle B is smaller than the predetermined value, controller 150 controls drive motor 134 of lifter 133 to release the lifted state of main body 101 using lifter 133 and return main body 101 to be in the normal state. After that, controller 150 controls running motor 136 of drive unit 130 to cause main body 101 to avoid obstacle B.

When the depth of the obstacle B is equal to or more than the predetermined value, controller 150 controls drive motor 134 of lifter 133 to bring main body 101 into the lifted state using lifter 133. Controller 150 subsequently controls running motor 136 of drive unit 130 to cause main body 101 to run on obstacle B without changing the traveling direction of main body 101 in the lifted state. Then, when main body 101 runs on obstacle B, controller 150 controls drive motor 134 of lifter 133 to release the lifted state of main body 101, using lifter 133, and then main body 101 is returned to be in the normal state.

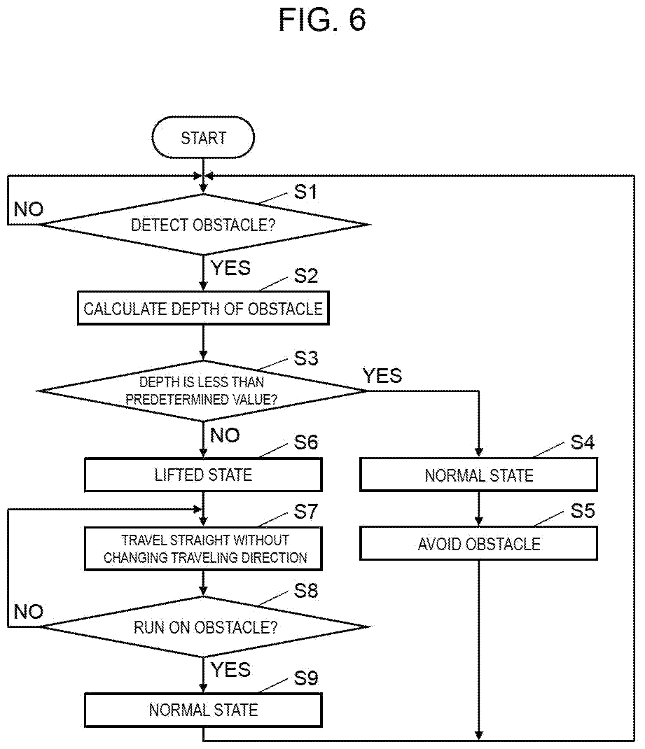

Hereinafter, one mode of operation for avoiding obstacle B and running on obstacle B among operations of self-propelled vacuum cleaner 100 will be described below with reference to FIG. 6.

FIG. 6 is a flowchart illustrating an avoidance operation and a running-on operation of self-propelled vacuum cleaner 100. The flowchart illustrated in FIG. 6 shows a flow when cleaning is performed.

As illustrated in FIG. 6, when cleaning is started, controller 150 first determines whether the obstacle detector detects obstacle B while main body 101 moves in a predetermined route (step S1). At this time, when obstacle B is not detected (NO in step S1), controller 150 continues the state in the same route.

In contrast, when obstacle B is detected (YES in step S1), controller 150 calculates a depth of obstacle B in the traveling direction of main body 101 based on the detection result of the obstacle detector (step S2).

Subsequently, controller 150 determines whether the calculated depth is smaller than the predetermined value (step 3). At this time, when the calculated depth is equal to or more than the predetermined value (NO in step S3), processing proceeds to step S6 described later.

In contrast, when the calculated depth is less than the predetermined value (YES in step S3), controller 150 controls drive motor 134 of lifter 133 to release the lifted state of main body 101 using lifter 133 and return main body 101 to be in the normal state (step 4).

Then, controller 150 controls running motor 136 of drive unit 130 to cause main body 101 to avoid obstacle B (step 5). This causes main body 101 to clean a cleaning area other than obstacle B while avoiding obstacle B without running on obstacle B.

After that, controller 150 proceeds to step S1 and executes subsequent steps.

Here, in step S3, when the depth is equal to or more than the predetermined value (NO in step S3), controller 150 controls drive motor 134 of lifter 133 to bring main body 101 into the lifted state using lifter 133 (step S6).

Controller 150 subsequently controls running motor 136 of drive unit 130 to cause main body 101 to run on obstacle B without changing the traveling direction of main body 101 (step S7).

Then, controller 150 determines whether main body 101 has run on obstacle B based on detection results of the various sensors (step S8). At this time, when main body 101 has not run on obstacle B (NO in step S8), the processing proceeds to step S7, and subsequent steps are repeated.

In contrast, when main body 101 has run on obstacle B (YES in step S8), controller 150 controls drive motor 134 of lifter 133 to release the lifted state of main body 101 using lifter 133 and return main body 101 to be in the normal state. This causes a distance between an upper surface of obstacle B and suction port 178 of cleaning unit 140 to be constant, so that main body 101 can clean by exerting normal suction force even on obstacle B.

After that, controller 150 proceeds to step S1 and executes subsequent steps.

As described above, the avoidance operation and the running-on operation of self-propelled vacuum cleaner 100 for obstacle B are performed.

Hereinafter, an operation example of self-propelled vacuum cleaner 100 for obstacle B will be described.

First, a specific operation example in which obstacle B is not avoided will be described with reference to FIG. 7.

FIG. 7 is an explanatory diagram illustrating an operation when self-propelled vacuum cleaner 100 does not avoid obstacle B. Specifically, part (a) of

FIG. 7 illustrates an operation of self-propelled vacuum cleaner 100 when obstacle B is detected forward. Part (b) of FIG. 7 illustrates a state in which self-propelled vacuum cleaner 100 runs on obstacle B.

As illustrated in part (a) of FIG. 7, controller 150 of self-propelled vacuum cleaner 100 first calculates depth D1 of obstacle B in the traveling direction (arrow Y1 in the drawing) of main body 101 when the obstacle detector detects obstacle B in a rectangular shape, for example. Then, controller 150 determines whether depth D1 detected is equal to or more than predetermined value P. Part (a) of FIG. 7 shows depth DI that is equal to or more than predetermined value P. Thus, self-propelled vacuum cleaner 100 runs on obstacle B in the lifted state (refer to arrow Y2 in the drawing), and is brought into the state illustrated in part (b) of FIG. 7. After that, controller 150 of self-propelled vacuum cleaner 100 switches a state of main body 101 from the lifted state to the normal state on obstacle B. This allows self-propelled vacuum cleaner 100 to move along arrow Y2 and clean on obstacle B.

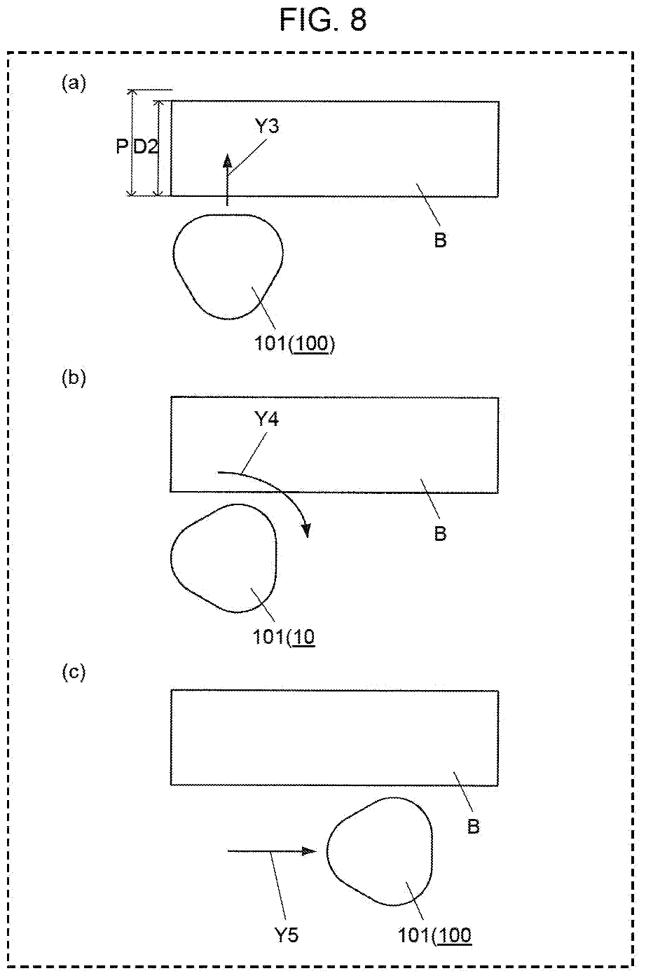

Next, an operation example in which obstacle B is avoided will be described with reference to FIG. 8.

FIG. 8 is an explanatory diagram illustrating an operation when self-propelled vacuum cleaner 100 avoids obstacle B. Specifically, part (a) of FIG. 8 illustrates an operation of self-propelled vacuum cleaner 100 when obstacle B is detected forward. Part (b) of FIG. 8 illustrates an operation of self-propelled vacuum cleaner 100 during change in direction. Part (c) of FIG. 8 illustrates an operation of self-propelled vacuum cleaner 100 during avoiding obstacle B.

As illustrated in part (a) of FIG. 8, self-propelled vacuum cleaner 100 first calculates depth D2 of obstacle B in the traveling direction (arrow Y3 in the drawing) of main body 101 when the obstacle detector detects obstacle B. Then, controller 150 determines whether depth D2 detected is equal to or more than predetermined value P. Part (a) of FIG. 8 shows depth D2 that is smaller than predetermined value P. Thus, as illustrated in part (b) of FIG. 8, self-propelled vacuum cleaner 100 turns 90 degrees to the right, for example, at that position without allowing main body 101 to enter obstacle B, and changes in direction (refer to arrow Y4 in the drawing).

After changing in direction, self-propelled vacuum cleaner 100 allows main body 101 to run on the floor surface while avoiding obstacle B as indicated by arrow Y5 in part (c) of FIG. 8.

As described above, self-propelled vacuum cleaner 100 of the present exemplary embodiment includes main body 101 that moves on the floor surface to clean floor surface, and the moving unit (drive unit 130) that is provided in main body 101 to move or turn main body 101. Main body 101 further includes an obstacle detector (obstacle sensor 173, ranging sensor 174, and camera 175) that detects obstacle B existing around main body 101. Self-propelled vacuum cleaner 100 further includes lifter 133 that is provided on main body 101 to lift main body 101 with respect to a floor surface, and controller 150 that controls the moving unit and lifter 133 based on a detection result of the obstacle detector.

Controller 150 calculates a depth of obstacle B in a traveling direction of main body 101 based on a detection result of the obstacle detector. When the depth is smaller than a predetermined value, controller 150 controls the moving unit to cause main body 101 to avoid obstacle B while controlling lifter 133 to release the lifted state using lifter 133.

This configuration allows main body 101 to avoid obstacle B in a state where the lifted state using lifter 133 is released, when the depth of obstacle B is smaller than the predetermined value. This enables reduction in frequency of passing over obstacle B while main body 101 remains in the lifted state, when the depth of the obstacle B is smaller than the predetermined value. That is, a frequency of main body 101 passing over obstacle B without exerting normal suction force can be reduced. As a result, certainty of cleaning obstacle B such as a rug having a depth of the predetermined value or more can be increased.

In this case, examples of obstacle B having a depth smaller than a predetermined value include miscellaneous goods, books, clothes, and the like on the floor surface, in addition to the rug narrow in width. That is, main body 101 can more reliably avoid miscellaneous goods, books, clothes, and the like. This enables interference between these and main body 101 to be suppressed. As a result, damage to obstacle B or main body 101 can be prevented.

The obstacle detector of self-propelled vacuum cleaner 100 of the present exemplary embodiment includes camera 175.

This configuration enables a shape (height, depth, etc.) of obstacle B to be easily recognized from an image captured by camera 175.

Controller 150 of self-propelled vacuum cleaner 100 of the present exemplary embodiment recognizes the shape of obstacle B based on a detection result of the obstacle detector.

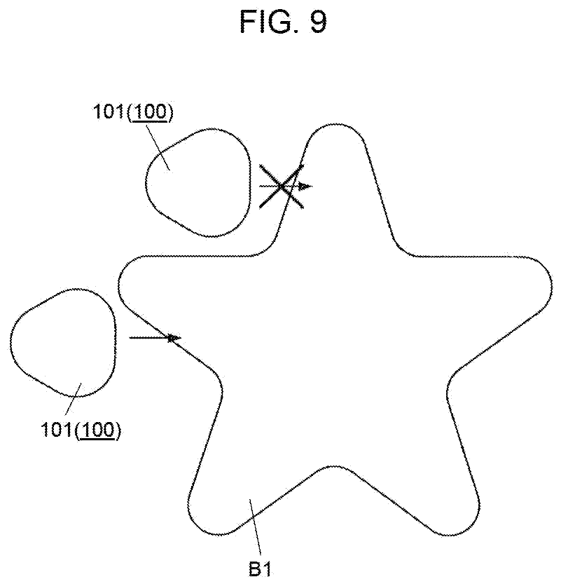

Hereinafter, an operation of self-propelled vacuum cleaner 100 for an obstacle having a shape different from that of obstacle B will be described with reference to FIG. 9.

FIG. 9 is an explanatory diagram illustrating the operation of self-propelled vacuum cleaner 100 for another example of an obstacle. FIG. 9 illustrates, for example, obstacle B1 having a star shape or the like, which is different from the rectangular shape shown in obstacle B.

That is, obstacle B1 has a shape in plan view that is more complicated than a rectangular shape, and thus has many portions each having a depth in a traveling direction of self-propelled vacuum cleaner 100, less than a predetermined value. This may cause avoidance operation to be complicated.

However, when the obstacle detector preliminarily recognizes the shape of obstacle B1, controller 150 can easily identify a position where self-propelled vacuum cleaner 100 can enter obstacle B1. Even after main body 101 runs on obstacle B1, main body 101 can be run along a shape of an upper surface of obstacle B1. This enables further increase in certainty of cleaning obstacle B1 of self-propelled vacuum cleaner 100.

The obstacle may have any shape in plan view other than a rectangular shape or a star shape. Examples of the shape include a polygonal shape, a circular shape, an elliptical shape, and the like.

The present invention is not limited to the above exemplary embodiment. For example, exemplary embodiments of the present invention may include another exemplary embodiment configured by appropriately combining components described in the present specification or excluding some of the components. The present invention also includes modifications obtained by making various modifications that can be conceived by those skilled in the art without departing from the scope of the gist of the present invention, i.e., the meaning indicated by the words described in the scope of claims.

For example, although the above exemplary embodiment describes the operation of main body 101 avoiding obstacle B as an example when the depth of obstacle B in the traveling direction of main body 101 is smaller than the predetermined value, the present invention is not limited to this. For example, controller 150 may be configured to detect a direction, in which obstacle B has a depth equal to or more than a predetermined value, before avoiding obstacle B.

Specifically, controller 150 first controls drive unit 130 to turn main body 101 and obtain a detection result of the obstacle detector at any time during turning before conducting avoidance using drive unit 130. At this time, when a direction of obstacle B in which obstacle B has a depth equal to or more than predetermined value P is detected, controller 150 controls lifter 133 to bring main body 101 into the lifted state. Then, controller 150 controls drive unit 130 to cause main body 101 to enter obstacle B from the direction of obstacle B having a depth of predetermined value P or more.

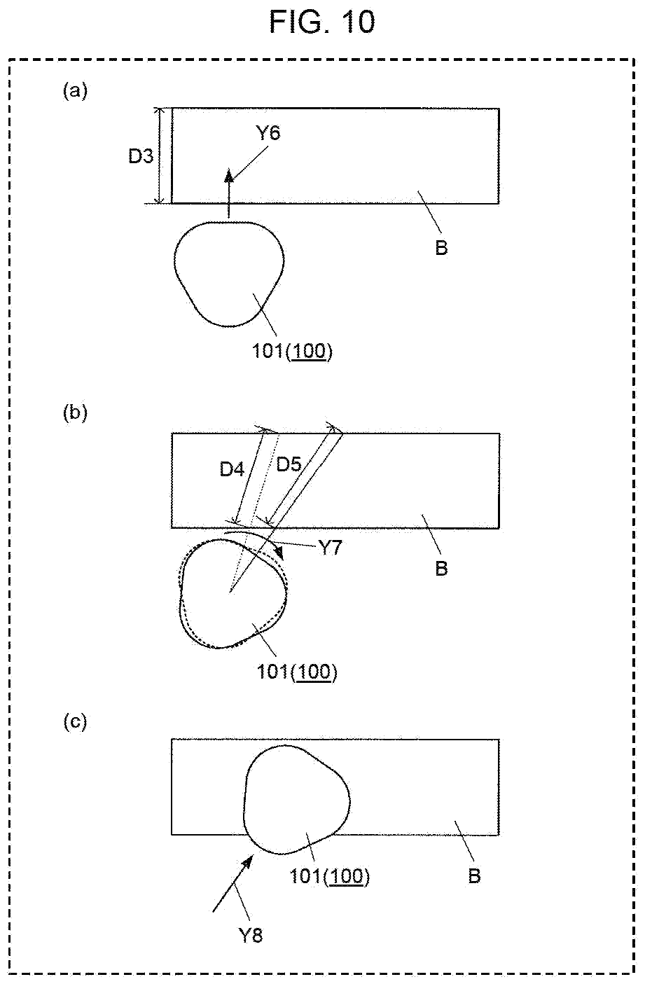

Hereinafter, an operation of self-propelled vacuum cleaner 100 for an obstacle will be described with reference to FIG. 10, in which a direction of obstacle B having a depth equal to or more than predetermined value P is detected and main body 101 is caused to enter obstacle B.

FIG. 10 is an explanatory diagram illustrating a direction detection operation of self-propelled vacuum cleaner 100. Specifically, part (a) of FIG. 10 illustrates a state of self-propelled vacuum cleaner 100 when obstacle B is detected forward. Part (b) of FIG. 10 illustrates a state of self-propelled vacuum cleaner 100 during change in direction. Part (c) of FIG. 10 illustrates a state in which self-propelled vacuum cleaner 100 runs on obstacle B.

As illustrated in part (a) of FIG. 10, controller 150 of self-propelled vacuum cleaner 100 first calculates depth D3 of obstacle B existing in the traveling direction indicated by arrow Y6 when obstacle B is detected. At this time, depth D3 in the state of part (a) of FIG. 10 is smaller than predetermined value P. Thus, as illustrated in part (b) of FIG. 10, self-propelled vacuum cleaner 100 turns in the direction indicated by arrow Y7 at that position without allowing main body 101 to enter obstacle B, and changes in direction. This turn causes the traveling direction of main body 101 to also turn. That is, main body 101 changes in traveling direction for obstacle B. At this time, controller 150 acquires a detection result from the obstacle detector at any time during turning. Then, controller 150 calculates a depth of obstacle B based on the acquired detection result. Part (a) of FIG. 10 shows a placement relationship before turning in which a depth of obstacle B in the traveling direction of main body 101 is D3, for example. However, turning of main body 101 illustrated in part (b) of FIG. 10 gradually increases a depth of obstacle B in the traveling direction of main body 101. That is, the depth changes from depth D3 to depth D4 or depth D5, for example, in accordance with turning. At this time, when the calculated depth is above predetermined value P, controller 150 controls lifter 133 to bring main body 101 into the lifted state. Next, controller 150 controls drive unit 130 to cause main body 101 to travel straight in the traveling direction at the current turning to enter obstacle B from the direction indicated by arrow Y8 illustrated in part (c) of FIG. 10. Then, after being run on obstacle B along the direction indicated by arrow Y8, main body 101 is run on obstacle B to clean obstacle B.

That is, controller 150 detects a direction in which obstacle B has a depth equal to or more than predetermined value P before conducting avoidance of main body 101. Then, controller 150 causes main body unit 101 to travel straight in the detected direction to enter obstacle B. This enables a useless avoidance operation of main body 101 for obstacle B to be suppressed. As a result, efficient cleaning using self-propelled vacuum cleaner 100 becomes possible.

### INDUSTRIAL APPLICABILITY

The present invention is applicable to a self-propelled vacuum cleaner that requires efficient cleaning workability and that is capable of autonomous running.

### REFERENCE MARKS IN THE DRAWINGS

100: self-propelled vacuum cleaner
101: main body
101a: front portion
101b: rear portion
119: collision sensor
130: drive unit (moving unit)
131: wheel
132: arm
132a: leading end portion
132b: base end portion
133: lifter
134: drive motor
135: angular velocity sensor
136: running motor
137: encoder
138: acceleration sensor
140: cleaning unit
150: controller
171: transmitter
172: receiver
173: obstacle sensor (obstacle detector)
174: ranging sensor (obstacle detector)
175: camera (obstacle detector)
176: floor surface sensor
178: suction port
179: caster
B, B1: obstacle
D1, D2, D3, D4, D5: depth
P: predetermined value
Y1, Y2, Y3, Y4, Y5, Y6, Y7, Y8: arrow

1. A self-propelled vacuum cleaner comprising:
a main body that moves on a floor surface to clean the floor surface;
a moving unit that is provided on the main body and moves or turns the main body;
an obstacle detector provided on the main body and detects an obstacle existing around the main body;
a lifter that is provided on the main body and lifts the main body from the floor surface; and
a controller that controls the moving unit and the lifter based on a detection result of the obstacle detector,
the controller calculating a depth of the obstacle in a traveling direction of the main body based on the detection result of the obstacle detector, and
the controller controlling the moving unit to cause the main body to avoid the obstacle while controlling the lifter to release the lifting of the main body, when the depth is smaller than a predetermined value.

2. The self-propelled vacuum cleaner according to claim 1, wherein
the controller acquires the detection result of the obstacle detector at any time during turning of the main body while controlling the moving unit to cause the main body to perform the turning of the main body before the main body conducts avoidance of the obstacle, and
the controller controls the moving unit to cause the main body to travel across the obstacle while controlling the lifter to lift the main body from the floor surface when the depth of the obstacle based on the detection result is equal to or more than the predetermined value.

3. The self-propelled vacuum cleaner according to claim 1, wherein the obstacle detector includes a camera.

4. The self-propelled vacuum cleaner according to claim 1, wherein the controller recognizes a shape of the obstacle based on a detection result of the obstacle detector.

5. The self-propelled vacuum cleaner according to claim 2, wherein the obstacle detector includes a camera.

6. The self-propelled vacuum cleaner according to claim 2, wherein the controller recognizes a shape of the obstacle based on a detection result of the obstacle detector.

7. The self-propelled vacuum cleaner according to claim 3, wherein the controller recognizes a shape of the obstacle based on a detection result of the obstacle detector.

8. The self-propelled vacuum cleaner according to claim 5, wherein the controller recognizes a shape of the obstacle based on a detection result of the obstacle detector.
